(19) United States
(12) Patent Application Publication
(10) Pub. No.: US 2026/0329042 A1
(43) Pub. Date: Oct. 22, 2026

(54) OPTIMIZED FIBER CONNECTIVITY SOLUTION FOR LARGE NETWORK FABRICS

(71) Applicant: Dell Products L.P., Round Rock, TX (US)

(72) Inventors: Weijing Chen, Round Rock, TX (US); Shawn Joel Dube, Austin, TX (US); Claudio Desanti, Santa Cruz, CA (US)

(21) Appl. No.: 19/182,062

(22) Filed: Apr. 17, 2025

(51) Int. Cl. G02B 6/44; G06F 1/18

(52) U.S. Cl. CPC G02B 6/4471; G06F 1/18

(57) ABSTRACT

A method for setting up a network fabric, the method includes connecting first cables from each port on a group of racks to corresponding front ports on a first group of panels in a sequential horizontal manner, where the first group of panels are arranged in a manner to form a first grid of ports, connecting second cables in a sequential vertical manner to back ports of the first grid of ports to obtain columns of cables, where each column of cables of the columns of cables corresponds to a column of back ports on the first grid of ports, connecting cables of each column of cables to corresponding leaf pods of a group of leaf pods, and connecting third cables from each leaf in the group of leaf pods to corresponding spine planes of a group of spine planes.

### BACKGROUND

Network fabrics play a critical role in computing systems by enabling communication between interconnected devices. These fabrics are composed of numerous switches, each physically linked through extensive cabling infrastructure. The setup process of these fabrics is often complex and labor intensive due to the substantial volume of cabling necessary to achieve full mesh connectivity across all switches.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a network fabric in accordance with one or more embodiments.

FIG. 2.1 shows a diagram of a first group of panels connected to a group of rack groups and a group of leaf pods in accordance with one or more embodiments.

FIG. 2.2 shows a diagram of a second group of panels connected to a group of spine planes and a group of core planes in accordance with one or more embodiments.

FIG. 2.3 shows a shows a diagram of a panel in accordance with one or more embodiments.

FIG. 3 shows a flowchart of a method for setting up shuffle racks in a network fabric in accordance with one or more embodiments.

FIG. 4 shows a flowchart of a method for setting up a network fabric in accordance with one or more embodiments.

FIG. 5 shows a diagram of a computing system in accordance with one or more embodiments.

### DETAILED DESCRIPTION

A network fabric is a highly scalable, low latency topology composed of interconnected switches that enable devices to communicate with minimal hops, often arranged in a rack-leaf-spine-core architecture. In a typical fabric, each leaf switch connects directly to every spine switch, and the leaf switches, in turn, connect to the rack-level devices such as servers, storage systems, graphic processing units (GPUs), etc. This full mesh interconnection between layers ensures that traffic can be evenly distributed across all available paths. Some implementations may include an additional core or super spine layers for interconnecting multiple spine switches for greater scalability and redundancy.

This layered and highly interconnected design enhances scalability and redundancy but introduces significant setup complexity due to the extensive cabling required at each layer, particularly between the rack and leaf and the spine and core, where the connection must be meticulously managed. Further, the difficulty in physically connecting the devices has greatly increased as network fabrics grow from thousands to tens of thousands and even to hundreds of thousands of interconnected devices. Traditional color-coding schemes often fall short in this environment due to the limited color spectrum and the sheer volume of cables, increasing the risk of errors that could compromise network performance and reliability. Even one incorrect connection can compromise the performance and stability of the fabric, and these errors can be especially difficult to identify and isolate due to the sheer number of cables and connections involved. Therefore, there is a need for an organized connection scheme within network fabrics that reduces the likelihood of cabling errors.

In light of the limitations discussed above, the method disclosed herein discusses a method for connecting cables within a network fabric using shuffle racks in a simple and organized manner.

Specific embodiments will now be described with reference to the accompanying figures.

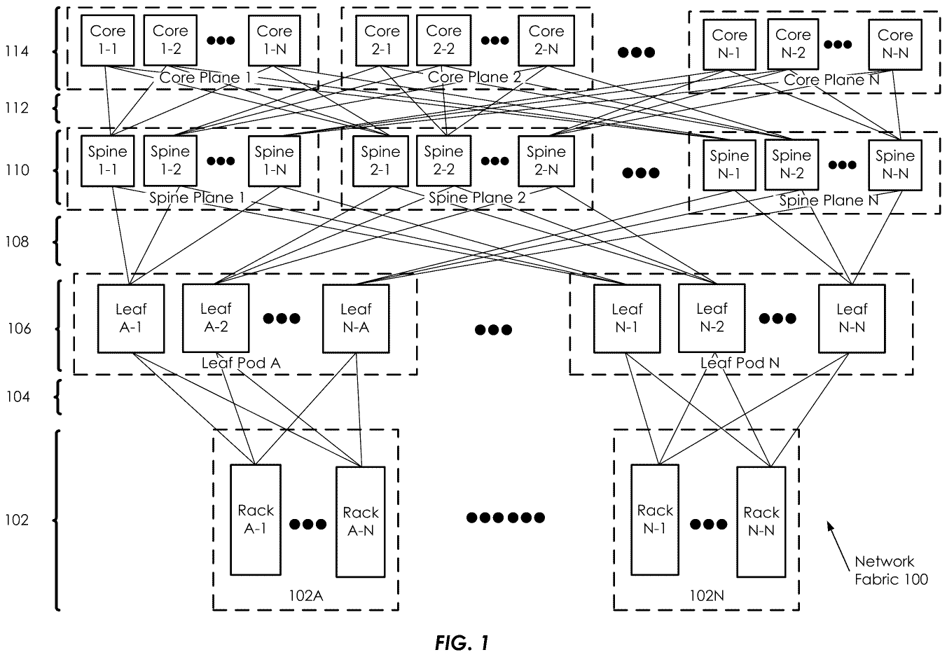

Turning to FIG. 1, FIG. 1 shows a diagram of a network fabric (100) in accordance with one or more embodiments disclosed herein. In one or more embodiments, a network fabric is a complete, interconnected mesh of network devices (e.g., racks, leaves, spines, cores, etc.) that facilitates efficient data transmission and forms the underlying infrastructure for a network. In one or more embodiments, the network fabric may (100) include a group of rack groups (102), where the group of rack groups (102) includes 102A-102N rack groups. In one or more embodiments, a rack refers to a shelf or frame for holding computing components (e.g., graphic processing units (GPUs) in an organized and secure manner). In one or more embodiments, each rack can hold any number of computing components, such as 12, 24, 36, 48, etc.

In one or more embodiments, the network fabric includes a group of leaf pods (106) with A-N leaf pods. In one or more embodiments, each rack in the group of rack groups (102) connects to all the leaves in a corresponding leaf pod (e.g., all the racks in rack group (102 A) connect to all of the leaf's in leaf pod A, and all the racks in rack group (102 N) connect to all of the leaf's in leaf pod N, by a first bunch of cables (104)). In one or more embodiments, each similarly situated computing component in each of the racks of a rack group connect to the same leaf in the corresponding leaf pod (e.g., each first computing component in each of the racks A-1 through A-N connect to leaf A-1).

In one or more embodiments, a leaf is a network switch, or group of switches, that connects directly to end devices (e.g., racks) and spines in the spine plane (110) and is operable to forward data (i.e., traffic) to and from spines in the spine plane (110) and racks in the rack groups (102). In one or more embodiments, a spine is a network switch, or group of switches, that connects to leaves and forwards traffic between different leaves. It should be appreciated, that the connection between the group of rack groups (102) and the group of leaf pods (106) directly links the devices in the racks to the network fabric, serving as the first step in data transmission within the network fabric (100). In one or more embodiments, the cables of the first bunch of cables (104) are network cables (e.g., fiber optic cables, copper cables, etc.). It should be appreciated, that depending on the size of the network, the connection between the group of rack groups (102) and the group of leaf pods (106) may include hundreds of thousands of cable connections.

In one or more embodiments, the network fabric includes a group of spine planes (110) with A-N spine planes. In one or more embodiments, each leaf in the group leaf pods (106) connects to all the spines in a corresponding spine plane of the group of spine planes (110) by a second bunch of cables (108). It should be appreciated, that the connection between the group of leaf pods (106) and the groups of spine planes (110) links all leaf switches of the group of leaf pods (106) together via spine switches of the group of spine planes (110) thereby ensuring efficient communication and redundancy within the network fabric (100). In one or more embodiments, the cables of the second bunch of cables (108) are network cables. In one or more embodiments, the connection scheme between group of leaf pods (106) and the group of spine planes (110) is as follows: leaf A-1 of leaf pod A is connected to spines 1-1, 1-2, and 1-N of spine plane 1, leaf A-2 of leaf pod A is connected to spines 2-1, 2-2, and 2-N of spine plane 2 . . . leaf A-N of leaf pod A is connected to spines N-1, N-2, and N-N of spine plane N, etc. It should be appreciated, that the connection scheme of connections between the leaves and spines shuffles the connections to allow interconnectivity between all of the racks of the group of rack groups (102) in the network fabric (100).

In one or more embodiments, the network fabric (100) includes a group of core planes (114). In one or more embodiments, each spine in the spine planes (110) connects to all the cores in a corresponding core plane (114) by a third bunch of cables (112). In one or more embodiments, a core (e.g., super spine) is a network switch, or group of switches, that connects to all spines and forwards traffic between different spines. It should be appreciated, that the connection between the group of spine planes (110) and the group of core planes (114) consolidates traffic from multiple spine switches by linking all of the spines of the group of spine planes (110), thereby increasing scalability and redundancy across the entire network fabric (100). In one or more embodiments, the cables of the third bunch of cables (112) are network cables. In one or more embodiments, the connection scheme between the group of spine planes (110) and the group of core planes (114) is as follows: spine 1-1 of spine plane 1 is connected to cores 1-1, 1-2, and 1-N of core plane 1, spine 2-1 of spine plane 1 is connected to core 2-1, 2-2, and 2-N of core plane 2 . . . spine 1-N of spine plane 1 is connected to spines N-1, N-2, and N-N of core plane N, etc., as shown in FIG. 1. It should be appreciated, that while the network fabric (100) shown in FIG. 1 has minimal connection and cables, network fabrics often include hundreds of thousands of cable can connections, making them challenging to set up.

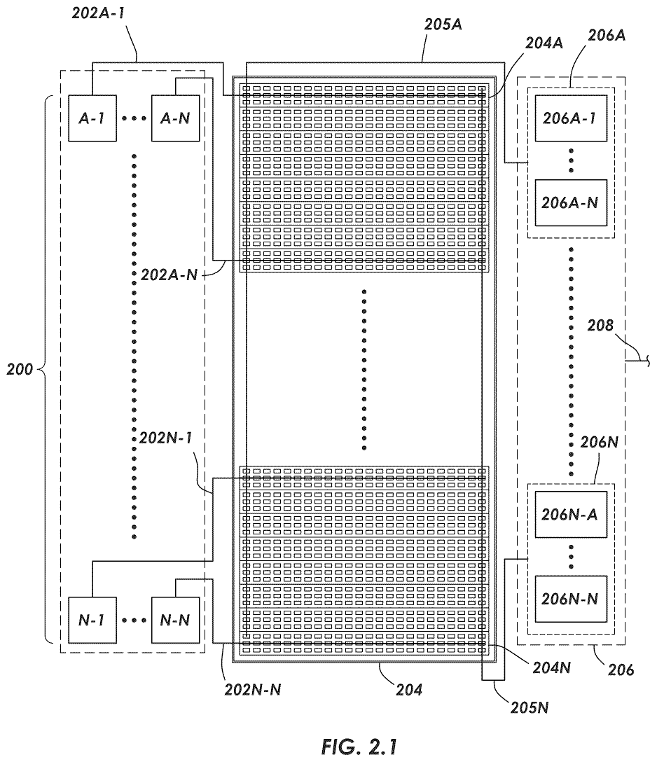

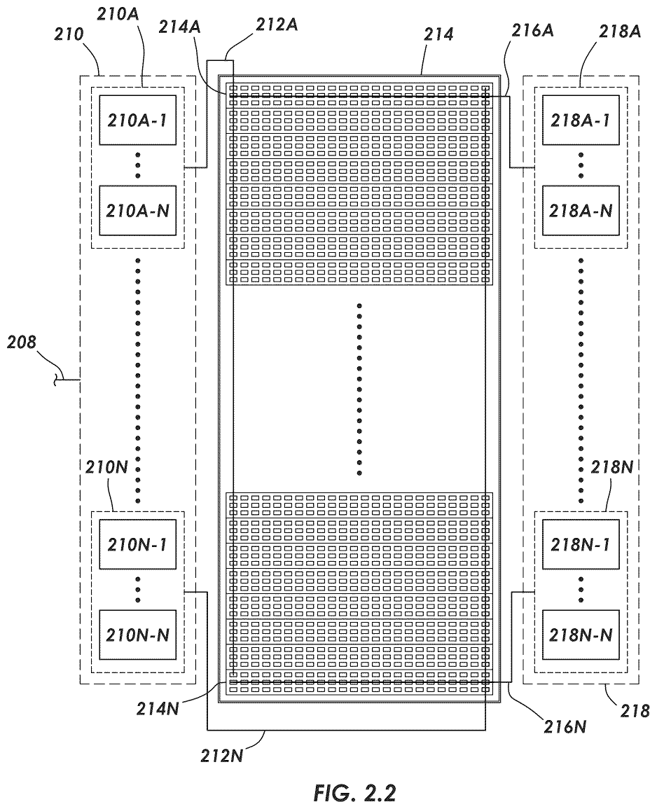

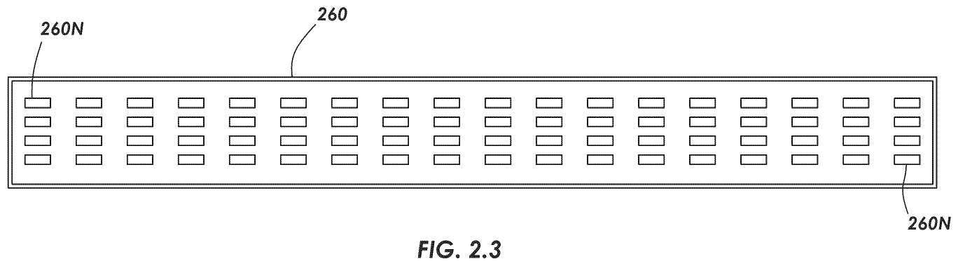

Turning to FIG. 2.1, FIG. 2.1 shows a diagram of a first group of panels (204) (e.g., a first shuffle rack) connected to a group of rack groups (200) and a group of leaf pods (206) in accordance with one or more embodiments disclosed herein. In one or more embodiments, the first group of panels (204), a first bunch of cables (202), and a second bunch of cables (205) replace the first bunch of cables (104) shown in FIG. 1 for each set of connections between a rack group (e.g., 102A) and a corresponding leaf pod (e.g., leaf pod A). In one or more embodiments, the first group of panels (204) is made up of 204A-204N panels. In one or more embodiments, each panel is identical to the panel (260) shown in FIG. 2.3 and discussed in further detail below. In one or more embodiments, the first group of panels (204) are arranged in a way to form a first grid of ports.

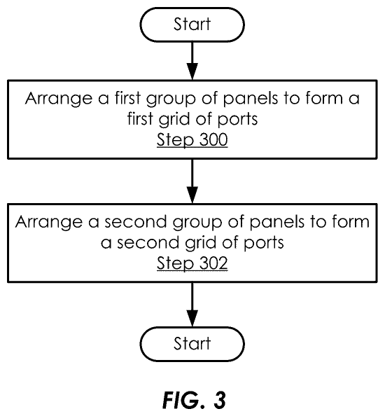

In one or more embodiments, each rack is the same as the racks shown in FIG. 1 and are discussed above. In one or more embodiments, the group of rack groups (200) is made up of A-N rack groups. In one or more embodiments, each rack group is made up of A-N racks. In one or more embodiments, each rack has A-N ports, depending on how many computing components it is holding. In one or more embodiments, a first bunch of cables (202) is connected from ports on each rack in the rack groups (200) to corresponding front ports on respective panels of the group of panels (204) in a horizontal sequential manner as described in FIG. 3. In one or more embodiments, the first bunch of cables (202) is made up of 202A-202N bunches of cables, where the number of cables corresponds to the number of computing components contained in the rack groups (200). FIG. 2.1 illustrates this connection by showing bunch cables (202A-1) connected from rack (A-1) to the front ports of panel (204A) in a horizontal manner and bunch of cables (202-N-N) is connected from rack (N-N) to the front ports panel (204N) in a horizontal manner. In a non-limiting example, port A-1 on rack A-1 is connected to front port A-1 on panel (204A), port A-2 on rack A-1 is connected to front port A-2 on panel (204A), etc. In one or more embodiments, the first bunch of cables (202) are network cables (e.g., fiber optic cables, copper cables, etc.).

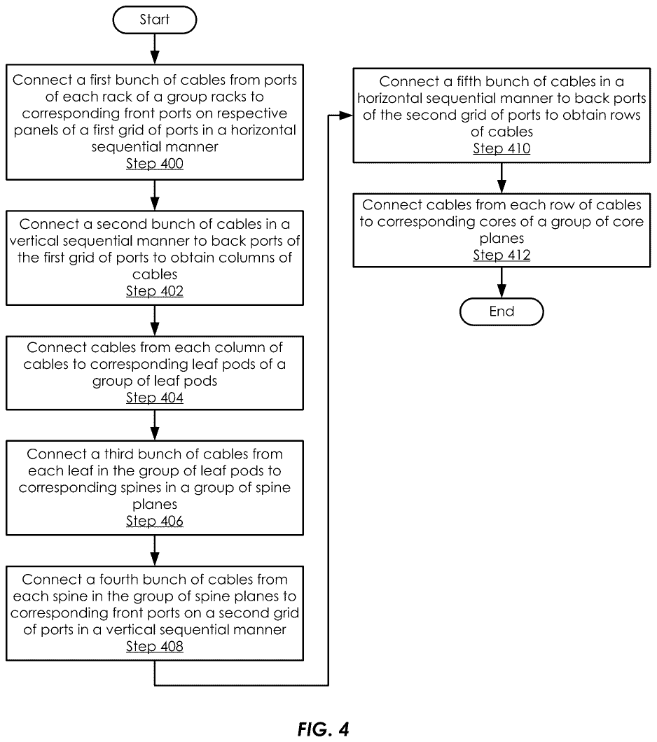

In one or more embodiments, a second bunch of cables (205) are connected from each column of the first grid of ports to corresponding leaf pods of a group of leaf pods (206), as described in FIG. 4. In one or more embodiments, the second bunch of cables (205) are made up of 205A-205N bunches of cables. In one or more embodiments, each leaf pod of the group of leaf pods (206) includes A-N leaves. In one or more embodiments, a leaf is a network switch that connects directly to end devices (e.g., racks) and forwards their traffic to and from spines, as shown in FIG. 1. In one or more embodiments, the group of leaf pods (206) includes A-N leaf pods. In one or more embodiments, each leaf pod includes A-N leaves. FIG. 2.1 illustrates the connection between the first grid or ports and the group of leaf pods (206) by showing bunch cables (202A) connected from all the back ports in the first column in the first grid of ports to leaves of leaf pod (206A) and bunch of cables (202 N) connected from all the back ports in the last column in the first grid of ports to leaves of leaf pod (206N). It should be appreciated, that the first grid of ports mimics the shuffling of traditional rack and leaf connections, as shown in FIG. 1. In one or more embodiments, the second bunch of cables (205) are network cables. It should be further appreciated that network fabrics often contain hundreds of thousands of connections, leaving room for error when setting up the fabrics, which is often done by hand and is thus prone to error. In one or more embodiments, each port of the first grid of ports has a number to match its corresponding rack port (e.g., leaf A-1 connects to port A-1, leaf A-2 connects to port A-2, etc.). It should be appreciated, that numbering the ports of the first gid of ports simplifies the connection process. It should be further appreciated, that that the use of the first grid or ports (e.g., the first shuffle rack) simplifies the connection process by eliminating the need for multi-color cables and confusing connection schemes used in traditional network fabrics, as shown in FIG. 1. In one or more embodiments, there are A-N first grids of ports connecting A-N groups of rack groups and A-N groups of leaf pods.

Turning to FIG. 2.2, FIG. 2.2 shows a diagram of a second group of panels (214) (e.g., a second shuffle rack) connected to a group of spine planes (210) and a group of core planes (218) in accordance with one or more embodiments disclosed herein. In one or more embodiments, the second group of panels (214), a fourth bunch of cables (212), and a fifth bunch of cables (216) replace the third bunch of cables (112) shown in FIG. 1 for each set of connections between the spine plane (e.g., 110) and the core plane (e.g., 114). In one or more embodiments, a group of leaf pods (206 in FIG. 2.1) is connected to the group of spine planes (210) by a third bunch of cables (208) as described in FIG. 1 and FIG. 4. In one or more embodiments, the third bunch of cables (208) is made up of A-N bunches of cables. In one or more embodiments, the third bunch of cables are network cables (e.g., fiber optic cables, copper cables, etc.). In one or more embodiments, the second group of panels (214) is made up of 214A-214N panels. In one or more embodiments, each panel is identical to panel 260 in FIG. 2.3. In one or more embodiments, the second group of panels (214) are arranged in a way to form a second grid of ports.

In one or more embodiments, a fourth bunch of cables (212) is connected from each spine in the group of spine planes (210) to corresponding front ports on the second grid of ports in a vertical sequential manner, as described in FIG. 4. In one or more embodiments, the fourth bunch of cables (212) include 214A-214N bunches of cables. In one or more embodiments, the fourth bunch (212) of cables are network cables (e.g., fiber optic cables, copper cables, etc.). In one or more embodiments, the group of spine planes (210) includes 210A-210N spine planes. In one or more embodiments, each spine plane of the group of spine planes (210) includes A-N spines. In one or more embodiments, a spine is a network switch that connects to all leaves and forwards traffic between different leaves, as shown in FIG. 1. In one or more embodiments, a leaf is a network switch that connects directly to end devices (e.g., racks) and forwards their traffic to and from spines, as shown in FIG. 1. In one or more embodiments, each spine plane of the group of spine plane is connected a column of ports of the second grid or ports. FIG. 2.2 illustrates the connection between the group of spines pods (210) and the second grid of ports by showing spine plane (210A) connected by bunch of cables (212A) to all of the front ports in the first row of columns of the second grid of columns and spine plane (210N) connected by bunch of cables (212N) to all of the front ports in the last row of columns of the second grid of columns.

In one or more embodiments, a fifth bunch of cables (216) is connected from each row on the back of the second grid of ports to corresponding core planes of a group of core planes (218) in a horizontal sequential manner, as described in FIG. 4. In one or more embodiments, the fifth bunch of cables (216) are made up of 216A-216N bunches of cables. In one or more embodiments, each core plane of the group of core planes (218) includes A-N cores. In one or more embodiments, a core (e.g., super spine) is a network switch that connects to all spines and forwards traffic between different spines, as shown in FIG. 1. FIG. 2.2 illustrates the connection between the second grid of ports and the group of core planes (218) by showing bunch of cables (216A) of the fifth bunch of cables (216) connected from all the ports in the first row in the second grid of ports to cores of core plane (218A) and bunch of cables (216N) of the first bunch of cables (216) connected from all the ports in the last row of ports in the second grid of ports to cores of core plane (218N). It should be appreciated, that the last row of ports is the last row of the second grid of ports that has cables connected to their corresponding front ports, as described in FIG. 4. It should be appreciated, that the second grid of ports mimics the shuffling of traditional spine and core connections, as shown in FIG. 1. It should be further appreciated that network fabrics often contain hundreds of thousands of connections, leaving room for error when setting up the fabrics, which is often done by hand. It should be appreciated, that the use of the second grid or ports (e.g., the second shuffle rack) simplifies the connection process by eliminating the need for multi-color cables and confusing connection schemes used in traditional network fabrics, as shown in FIG. 1. Instead, each cable can simply have a number associated with it (e.g., inscribed on the cable, on a tag attached to the cable, etc.) and a technician can simply plug each cable in sequential order in the horizontal or vertical order, thereby greatly reducing the chance of an error occurring. In one or more embodiments, there are A-N second grids of ports connecting A-N groups of spine planes and A-N groups of core planes.

Turning to FIG. 2.3, FIG. 2.3 shows a diagram of a panel (260) in accordance with one or more embodiments disclosed herein. In one or more embodiments, the panel (260) is an optical panel (e.g., a device for managing and organizing network cable (e.g., network cables including but not limited to fiber optic cables, copper cables, etc.) connections in a network fabric (e.g., 100 in FIG. 1)). In one or more embodiments, the ports of the panel (260) are configured to receive network cables. In one or more embodiments, the panel (260) includes a grid of ports 260A-260N. In one or more embodiments, the panel (260) may be configured to have the same number of ports as a rack (e.g., shelf or frame for holding computing components (e.g., graphic processing units (GPUs) in an organized and secure manner) that it is connected to, as described in FIG. 4. In one or more embodiments, multiple panels (260) can be arranged to create a shuffle rack (e.g., large grid of ports) as discussed in FIG. 3. In one or more embodiments, the panel includes front and back ports, where each front port corresponds to a back port. In a non-limiting example, front port A-1 and back port A-1 correspond to each other, front port A-2 and back port A-2 correspond to each other, etc.

Turning to FIG. 3, FIG. 3 shows a flowchart of a method for setting up shuffle racks in a network fabric in accordance with one or more embodiments disclosed herein. The method may be performed by, for example, a user. Other components in the system may perform this method without departing from the scope of the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3 may be performed concurrently with one or more steps in FIGS. 3-4.

In step 300, the user arranges a first group of panels (e.g., 204 in FIG. 2.1) to form a first grid of ports. In one or more embodiments, the first grid of ports may be referred to as a first shuffle rack. In one or more embodiments, each panel of the first group of panels is identical to panel 260 in FIG. 2.3. In one or more embodiments, the first grid of ports is made up of rows and columns of ports. In one or more embodiments, the user arranges the first group of panels to form the first grid of ports by any means known in the art or discovered in the future.

In step 302, the user arranges a second group of panels (e.g., 214 in FIG. 2.2) to form a second grid of ports. In one or more embodiments, the second grid of ports may be referred to as a second shuffle rack. In one or more embodiments, each panel of the second group of panels is identical to panel 260 in FIG. 2.3. In one or more embodiments, the second grid of ports is made up of rows and columns of ports. In one or more embodiments, the user arranges the second group of panels to form the second grid of ports by any means known in the art or discovered in the future.

In one or more embodiments, the method ends following step 302.

Turning to FIG. 4, FIG. 4 shows a flowchart of a method for setting up a network fabric (e.g., 100 in FIG. 1) in accordance with one or more embodiments disclosed herein. The method may be performed by, for example, a user. Other components in the system may perform this method without departing from the scope of the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 4 may be performed concurrently with one or more steps in FIGS. 3-4.

In one or more embodiments, a topology of the network fabric (i.e., the connections between and locations of each of the devices of the network fabric) is designed. Then a group of individuals is tasked with physically building the network fabric in accordance with the topology, which, as previously discussed, can include many thousands of devices and connections. The method provided in FIG. 4 greatly reduces the complexity of this building step, thereby reducing the error rate and time to complete the building of the network fabric.

Turning to the method, in step 400, the user connects a first bunch of cables (e.g., 202 in FIG. 2.1) from ports on each rack (e.g., shelf or frame for holding computing components (e.g., graphic processing units (GPUs) in an organized and secure manner) in a group of rack groups (e.g., 200 FIG. 2.1) to corresponding front ports on respective panels of a first grid of ports (e.g., shuffle rack one) , as shown in FIG. 2.1. In one or more embodiments, the first bunch of cables are network cables (e.g., fiber optic cables, copper cables, etc.). In one or more embodiments, each rack of the group of rack groups contains A-N GPUs. In one or more embodiments, each of the A-N GPUs has a port. In one or more embodiments, the first grid of ports is the same first grid of ports, as described in FIG. 3. In one or more embodiments, the first grid of ports is made up of rows and columns of ports as described in FIG. 3. In one or more embodiments, each cable of the first bunch of cables connects the respective ports on respective racks to the respective ports on respective panels in a horizontal sequential manner progressing from one row to the next of the first grid of ports. In a non-limiting example, a cable is connected from port A-1 of rack A to row A port A-1 of panel A, from port A-2 of rack A to row A port A-2 of panel A . . . from port A-N of rack A to row N port A-N of panel A, from port B-1 of rack B to row A port B-1 of panel B, from port B-2 or rack B to row A port B-2 of panel B . . . from port B-N of rack B to row N port B-N of panel B, etc. In one or more embodiments, each panel of the first grid or ports has the same number of ports as each rack. It should be appreciated, that designing a panel to have the same number of ports as the racks simplifies the connection process. In one or more embodiments, each port on the group of rack groups is numbered to match its corresponding port on the panels of the first grid of ports. It should be further appreciated that this is useful in large network fabrics with hundreds of thousands of cables and connections where the setup process is tedious and difficult. In one or more embodiments, each panel of the first grid or ports does not have the same number of ports as each rack. It should be appreciated, that due to sourcing issues, it may be impossible to obtain all the components, such as GPUs for the racks or design panels design match the racks. It should be further appreciated, the number of ports in each rack may not line up with the number of ports on each panel, leading to more than one rack being connected to a singular panel. In a non-limiting example, rack A includes ports A1-A7, and rack B includes ports B1-B7 and panel A includes ports A1-A14; thus cables are connected from ports A1-A7 of rack A to ports A1-A7 of panel A, respectively, and cables are connected from ports B1-B7 of rack B to ports A8-A14 of panel A, respectively.

In step 402, the user connects a second bunch of cables (e.g., 205 in FIG. 2.1) in a vertical sequential manner to back ports of the first grid of ports to obtain columns of cables, as shown in FIG. 2.1. In one or more embodiments, the second bunch of cables are network cables. In one or more embodiments, the columns of cables include the sets of cables connected to each column on the back of the first grid of ports. In a non-limiting example, column of cables A includes all of the cables connected to column A of the first grid of ports, column of cables B includes all of the cables connected to column B of the first grid of ports, etc. In one or more embodiments, the cables of the second bunch of cables are only connected to back ports of the first grid of ports that have cables connected to the corresponding front ports as described in step 400. In a non-limiting example, if there are only cables connected to ports A1-A7 in column A on the front ports in the first grid of ports, then cables of the second bunch of cables will only be connected to ports A1-A7 in column A on the back of the first grid of ports.

In step 404, the user connects cables from each column of the column of cables to corresponding leaf pods of a group of leaf pods (e.g., 206 in FIG. 2.1), as shown in FIG. 2.1. In one or more embodiments, each leaf pod of the group of leaf pods includes a group of A-N leaves. In one or more embodiments, a leaf is a network switch that connects directly to end devices (e.g., racks) and forwards their traffic to and from spines, as shown in FIG. 1. In one or more embodiments, a spine is a network switch that connects to all leaves and forwards traffic between different leaves, as shown in FIG. 1. In one or more embodiments, the cables of each column of cables are connected to respective leaves. In one or more embodiments, the ports of the leaves are numbered to match their cables in each of the columns of cables. Continuing with the non-limiting example in step 402, all cables in column of cables A are connected to leaves of leaf pod A, all cables in column of cables B get connected to leaves of leaf pod B, etc. Further, cable A-1 of column of cables A is connected to leaf A-1, cable A-2 of column of cables A is connected to leaf A-2 . . . cable A-N of column of cables A is connected to leaf A-N, cable B-1 of column of cables B is connected to leaf B-1, cable B-2 of column of cables B is connected to leaf B-2 . . . cable B-N of column of cables B is connected to leaf B-N, etc. It should be appreciated, the connections of the group of rack groups and the group of leaf pods through the first grid of ports mimics the shuffling that occurs between racks and leaves in the network fabric, as shown in FIG. 1. It should further be appreciated, that the use of the first grid of ports simplify the connection process by introducing an easy-to-use connection scheme.

In step 406, the user connects a third bunch of cables (e.g., 208 in FIG. 2.2) from each leaf in the group of leaf pods to the corresponding spines in a group of spine planes (e.g., 210) as described in FIGS. 1 and 2.2. In one or more embodiments, the third bunch of cables are network cables. In one or more embodiments, each leaf in the leaf pods connects to all the spines in a corresponding spine plane as shown in FIG. 1. In a non-limiting example, leaf A-1 of leaf pod A is connected to spines 1-1, 1-2, and 1-N of spine plane 1, leaf A-2 of leaf pod A is connected to spines 2-1, 2-2, and 2-N of spine plane 2 . . . leaf A-N of leaf pod A is connected to spines N-1, N-2, and N-N of spine plane N, etc., as shown in FIG. 1. It should be appreciated, this configuration allows for redundancy, load balancing, and improved network resilience by ensuring multiple paths between leaves and spines.

In step 408, the user connects a fourth bunch of cables (e.g., 212 FIG. 2.2) from each spine in the group of spine planes to corresponding front ports on a second grid of ports (e.g., shuffle rack two) in a vertical sequential manner, as shown in FIG. 2.2. In one or more embodiments, the fourth bunch of cables are network cables. In one or more embodiments, the second grid of ports is the same second grid of ports, as described in FIG. 3. In one or more embodiments, the second grid of ports is made up of rows and columns of ports as described in FIG. 3. In one or more embodiments, each spine plane of the group of spine planes corresponds to a column in the second grid of ports. In a non-limiting example, column A of the second grid of ports includes all of the cables from the spines in spine plane A, column B of the second grid of ports includes all of the cables from the spines in spine plane B, etc. In one or more embodiments, each of the ports in each of the columns of the second grid of ports corresponds to a spine in the group of spine planes. In one or more embodiments, the ports of the second grid of ports are numbered to match their corresponding spine in the group of spine planes. Continuing with the non-limiting example, spine A-1 of spine plane A is connected to column A port A-1 of the second grid of ports, spine A-2 of spine plane A is connected to column A port A-2 of the second grid of ports . . . spine A-N of spine plane A is connected to column A port A-N of the second grid of ports, spine B-1 of spine plane B is connected to column B port B-1 of the second grid of ports, spine B-2 of spine plane B is connected to column B port B-2 of the second grid of ports . . . spine B-N of spine plane B is connected to column B port B-N of the second grid of ports, etc.

In step 410, the user connects a fifth bunch of cables (e.g., 216 in FIG. 2.1) in a horizontal sequential manner to back ports of the second grid of ports to obtain rows of cables, as shown in FIG. 2.2. In one or more embodiments, the fifth bunch of cables are network cables. In a non-limiting example, row of cables A includes all of the cables connected to row A of the second grid of ports, row of cables B includes all of the cables connected to row B of the second grid of ports, etc. In one or more embodiments, the cables of the fifth bunch of cables are only connected to back ports of the second grid of ports that have cables connected to the corresponding front ports as described in step 408. In a non-limiting example, if there are only cables connected to ports A1-A7 in row A on the front ports in the second grid of ports, then cables of the fifth bunch of cables will only be connected to ports A1-A7 in row A on the back of the second grid of ports.

In step 412, the user connects cables from each row of cables to corresponding cores in a group of core planes (e.g., 218 in FIG. 2.2), as shown in FIG. 2.2. In one or more embodiments, a core (e.g., super spine) is a network switch that connects to all spines and forwards traffic between different spines, as shown in FIG. 1. In one or more embodiments, the cables of the rows of cables are connected to the cores of the core planes sequentially until all of the cores in are filled before moving to the next core. In a non-limiting example, row of cables A has A1-A7 cables, row of cables B has B1-B7 cables, and core plane A has 10 cores and core plane B has 10 cores, thus cables A1-A7 and B1-B3 are connected to the 10 cores of corn plane A and the rest of the cables of row of cables B are connected to the cores of core plane B. In one or more embodiments, the core planes are numbered to match the respective cables or the rows of cables. In one or more embodiments, the number of cables on each panel of the second grid of ports matches the number of cores in each core plane. It should be appreciated, the connections of the group spine planes and the group core planes through the second grid of ports mimics the shuffling that occurs between spines and cores in the network fabric, as shown in FIG. 1. It should further be appreciated, that the use of the second grid of ports simplifies the connection process by introducing an easy-to-use connection scheme.

In one or more embodiments, the method ends following step 412.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 4 may be performed concurrently with one or more steps in FIGS. 3-4.

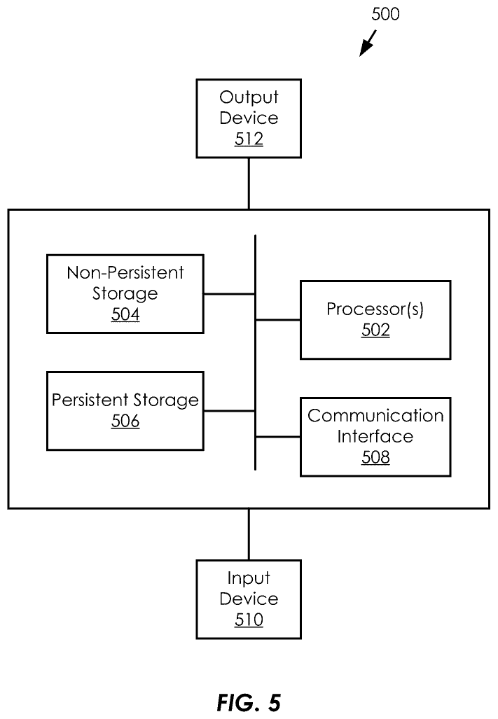

Embodiments of the disclosure may be implemented using computing devices. Turning to FIG. 5, FIG. 5 shows a diagram of a computing device (500) in accordance with one or more embodiments. The computing device (500) may include one or more computer processor(s) (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), input devices (510), output devices (512), and numerous other elements (not shown) and functionalities. Each of these components is described below.

In one embodiment, the computer processor(s) (502) may be an integrated circuit for processing instructions. For example, the computer processor(s) (502) may be one or more cores or micro-cores of a processor. The computing device (500) may also include one or more input devices (510), such as a touchscreen, access keyboard, mouse, microphone, touchpad, electronic pen, or any other type of input device. The communication interface (508) may include an integrated circuit for connecting the computing device (500) to a network (e.g., a local area network (LAN), a wide area network (WAN) such as the Internet, mobile network, or any other type of network) and/or to another device, such as another computing device.

In one embodiment, the computing device (500) may include one or more output devices (512), such as a screen (e.g., a liquid crystal display (LCD), a plasma display, touchscreen, cathode ray tube (CRT) monitor, projector, or other display device), a printer, external storage, or any other output device. One or more of the output devices (512) may be the same or different from the input devices (510). The input and output device(s) (510, 512) may be locally or remotely connected to the computer processor(s) (502), non-persistent storage (504), and persistent storage (506). Many diverse types of computing devices exist, and the aforementioned input and output device(s) (510, 512) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (e.g., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for setting up a network fabric, the method comprising connecting a first plurality of cables from each port on a plurality of racks to corresponding front ports on a first plurality of panels in a sequential horizontal manner, wherein the first plurality of panels is arranged in a manner to form a first grid of ports;
connecting a second plurality cables in a sequential vertical manner to back ports of the first grid of ports to obtain columns of cables, wherein each column of cables of the columns of cables corresponds to a column of back ports on the first grid of ports; and
connecting cables of each column of cables to corresponding leaf pods of a plurality of leaf pods, wherein:
each leaf pod of the plurality of leaf pods contains a plurality of leaves,
each column of cables is associated with a separate leaf pod of the plurality of leaf pods, and
each cable of the columns of cables is connected to a corresponding leaf within the separate leaf pod.

2. The method of claim 1, further comprising:
connecting a third plurality of cables from each leaf in the plurality of leaf pods to corresponding spine planes of a plurality of spine planes, wherein each of the plurality of spine planes contains a plurality of spines.

3. The method of claim 2 further comprising:
connecting a fourth plurality of cables from each spine in the plurality of spines to corresponding front ports on a second plurality of panels, wherein:
the second plurality of panels are arranged in a manner to form a second grid of ports,
each spine plane of the plurality of spine planes corresponds to a column of ports in the second grid of ports, and
the fourth plurality of cables are connected from the spines of each spine plane of the plurality of spine planes to the corresponding columns in a sequential vertical manner;
connecting a fifth plurality of cables in a sequential horizontal manner to back ports of the second grid of ports to obtain rows of cables, wherein each row of cables of the rows of cables corresponds to a row of back ports on the second grid of ports; and
connecting cables from each row of cables to corresponding cores of a plurality of core planes wherein:
each core plane of the plurality of core planes contains a plurality of cores, and
each cable of the columns of cables is connected to a corresponding core within the core planes.

4. The method of claim 3, wherein the leaves, the spine, and the cores, are network switches of the network fabric.

5. The method of claim 1, wherein the panels of the first plurality of panels are optical panels.

6. The method of claim 1, wherein the first plurality of cables are fiber optic cables.

7. The method of claim 1, wherein the plurality of racks comprise of graphic processing units.

8. The method of claim 1, wherein the first grid of ports is a shuffle rack.

9. A method for setting up a network fabric, the method comprising
connecting a first plurality of cables from each port on a plurality of racks to corresponding front ports on a first plurality of panels in a sequential horizontal manner, wherein the first plurality of panels is arranged in a manner to form a first grid of ports;
connecting a second plurality of cables in a sequential vertical manner to back ports of the first grid of ports to obtain columns of cables, wherein:
each column of cables of the columns of cables corresponds to a column of back ports on the first grid of ports,
the back ports of the first grid of ports correspond to front ports of the first grid of ports, and
cables of the second plurality of cables are only connected to back ports of the first grid of ports that have a corresponding front port with a cable from the first plurality of cables connected; and
connecting cables of each column of cables to corresponding leaf pods of a plurality of leaf pods, wherein:
each leaf pod of the plurality of leaf pods contains a plurality of leaves,
each column of cables is associated with a separate leaf pod of the plurality of leaf pods, and
each cable of the columns of cables is connected to a corresponding leaf within the separate leaf pod.

10. The method of claim 9, further comprising:
connecting a third plurality of cables from each leaf in the plurality of leaf pods to corresponding spine planes of a plurality of spine planes, wherein each of the plurality of spine planes contains a plurality of spines.

11. The method of claim 10, further comprising:
connecting a fourth plurality of cables from each spine in the plurality of spines to corresponding front ports on a second plurality of panels, wherein:
the second plurality of panels are arranged in a manner to form a second grid of ports,
each spine plane of the plurality of spine planes corresponds to a column of ports in the second grid of ports, and
the fourth plurality of cables are connected from the spines of each spine plane of the plurality of spine planes to the corresponding columns in a sequential vertical manner;
connecting a fifth plurality of cables in a sequential horizontal manner to back ports of the second grid of ports to obtain rows of cables, wherein:
each row of cables of the rows of cables corresponds to a row of back ports on the second grid of ports
the back ports of the second grid of ports correspond to front ports of the second grid of ports, and
cables of the fifth plurality of cables are only connected to back ports of the second grid of ports that have a corresponding front port with a cable from the fourth plurality of cables connected; and
connecting cables from each row of cables to corresponding cores of a plurality of core planes wherein:
each core plane of the plurality of core planes contains a plurality of cores, and
each cable of the columns of cables is connected to a corresponding core within the core planes.

12. The method of claim 11, wherein the leaves, the spine, and the cores, are network switches of the network fabric.

13. The method of claim 9, wherein the panels of the first plurality of panels are optical panels.

14. The method of claim 9, wherein the first plurality of cables are fiber optic cables.

15. The method of claim 9, wherein the plurality of racks comprise of graphic processing units.

16. A system for setting up a network fabric, the system comprising:
a first plurality of cables, a second plurality of cables, a third plurality of cables, a fourth plurality of cables, and a fifth plurality of cables;
a plurality of racks;
a first plurality of panels and a second plurality of panels;
a plurality of leaf pods;
a plurality of spine planes; and
a plurality of core planes, wherein the network fabric is arranged such that:
the first plurality of cables are connected from each port on the plurality of racks to corresponding front ports on the first plurality of panels in a sequential horizontal manner, wherein the first plurality of panels is arranged in a manner to form a first grid of ports;
the second plurality cables are connected in a sequential vertical manner to back ports of the first grid of ports to obtain columns of cables, wherein each column of cables of the columns of cables corresponds to a column of back ports on the first grid of ports; and
cables of each column of cables are connected to corresponding leaf pods of the plurality of leaf pods, wherein:
each leaf pod of the plurality of leaf pods contains a plurality of leaves,
each column of cables is associated with a separate leaf pod of the plurality of leaf pods, and
each cable of the columns of cables is connected to a corresponding leaf within the separate leaf pod.

17. The system of claim 16, wherein the network fabric is further arranged such that:
the third plurality of cables are connected from each leaf in the plurality of leaf pods to corresponding spine planes of the plurality of spine planes, wherein each of the plurality of spine planes contains a plurality of spines.

18. The system of claim 17, wherein the network fabric is further arranged such that:
the fourth plurality of cables are connected from each spine in the plurality of spines to corresponding front ports on a second plurality of panels, wherein:
the second plurality of panels are arranged in a manner to form a second grid of ports,
each spine plane of the plurality of spine planes corresponds to a column of ports in the second grid of ports, and
the fourth plurality of cables are connected from the spines of each spine plane of the plurality of spine planes to the corresponding columns in a sequential vertical manner;
the fifth plurality of cables are connected in a sequential horizontal manner to back ports of the second grid of ports to obtain rows of cables, wherein each row of cables of the rows of cables corresponds to a row of back ports on the second grid of ports; and
cables from each row of cables are connected to corresponding cores of a plurality of core planes wherein:
each core plane of the plurality of core planes contains a plurality of cores, and
each cable of the columns of cables is connected to a corresponding core within the core planes.

19. The system of claim 18, wherein the leaves, the spine, and the cores, are network switches of the network fabric.

20. The system of claim 16, wherein the panels of the first plurality of panels are optical panels.
